(19) United States
(12) Patent Application Publication
(10) Pub. No.: US 2006/0113417 A1
(43) Pub. Date: Jun. 1, 2006

(54) Skid resistant waste containment system and the manufacturing process of

(76) Inventor: Suzan Delain Mackey, Burns, OR (US)

Correspondence Address: Suzan Delain Mackey, P.O. Box 91, Hines, OR, 97738, US

(21) Appl. No.: 10/983,300

(22) Filed: Nov. 8, 2004

(51) Int. Cl. B02C 13/286

(52) U.S. Cl. 241/301

(57) ABSTRACT

A Portable Skid Resistant Waste Containment System contains wastes generated by washing vehicles or other articles or any other containment needs or acts suitable. The system has skid resistant product(s) applied to the surface as an added safety feature for performing tasks within the containment system. Embodiment is preferably comprised of a resilient, fluid resistant, durable, pliable 30 mil geo-membrane material, XR5, which comprises a waste containment floor and any number of containment wall housings, depending on the shape, using the fold and weld manufacturing process herein this patent application. Other materials may be used as well, with similar results. The containment wall housings are designed to accommodate a variety of optional articles to be placed within the housings, to create the desired size and internal integrity of containment walls. The versatility of the fold and weld manufacturing process, allows the same manufacturing process to facilitate a wide variety of shapes and sizes. The system is portable, the constant access to wall housing allows the removal of any articles place within the wall housing. The manufacturing process offered as a portion of this invention, allows easy folding and moving capabilities. Alternatively, when using the Portable Skid Resistant Waste Containment System, an underlay pad is used to protect against surface damage, preferably comprised of a geo-textile style fabric

### CROSS REFERANCE TO RELATED APPLICATIONS

Not Applicable

### REFERENCE TO SEQUENCE LISTING A TABLE

Not Applicable

### STATEMENT REGARDING FEDERALLY SPONCERD RESEARCH

Not Applicable

### BACKGROUND OF INVENTION

My invention is drawn towards my needs as an individual to have a safer work environment for myself, as well as others, and the flexibility, that the design and manufacturing process of use my invention provides, The Skid Resistant Waste Containment System.

### SUMMARY OF INVENTION

My invention is a Portable Skid Resistant Waste Containment System. The unique things about this invention, is the process of manufacture, the versatility, and the safety feature. The containment system, I feel will solve several problems that exist in present day waste containment systems.

The safety feature (application of skid resistant product(s), solves the problem that there is no protection for operators of such system that I have seen. This application of skid resistant products applied to the surfaces of my invention, I believe is the first of its kind. The purpose of a containment system is to collect fluids or waste that are harmful to the environment, most containing ingredients, that when present on walking surfaces, creates a hazard of slipping or falling when walked upon, thus resulting in injury. With the application of one or more existing slip resistant products added to the working environment within the containment systems, it provides a safer environment for individuals to access the containment system and perform tasks therein. As the inventor of this concept, I feel as though the absents of such a product(s) is unbelievable. Thousands of people each year are injured from slip and fall accidents, which some could have been avoided, had safety measures been in place to prevent it. I don't claim that this safety feature, that is part of my invention, will guarantee that a fall will not occur, but having it available to an already potentially hazardous walking surface, is better than not, in my opinion.

The manufacturing process for my invention is what allows for the versatility aspects. The process allows for the same containment ability's using the same manufacturing process, entertaining and meeting more containment system requirement needs. Some need the waste containment walls to be rigid, some need to be flexible for driving over, and some need to have a combination of walls. Waste containment wall height requirements also vary. My system allows the user to permanent access to the wall housings, so that the function ability conforms to the users needs. It also makes it very portable with walls removed. The material it is comprised with is highly rated for containment of hazardous materials.

### DETAILED DESCRIPTION OF THE INVENTION

The Portable Skid Resistant Waste Containment System is used to contain waste generated by washing vehicles or other articles, or any other containment needs or acts appropriate. Preferably constructed of a resilient, fluid resistant, durable, pliable 30 mil geo-membrane material, XR5 or another, or a combination of materials in part or in its entirety which supports the application purpose and use.

The containment system has a safety feature, alternatively, the surface application of one or more skid resistant products, in one or more application methods appropriate of system application requirements. The application of such products in part or in its entirety of surface area, provides an added slip resistant surface as a safety aid while performing tasks within the containment area. Most fluids or petroleum based products create slippery surfaces when present, which could results in injury in the event of a fall. This safety feature does not claim to guarantee that a fall due to slipping will not occur, but is intended as a safety precaution designed to offer a working surface with a slip resistant surface. The products and the surface coverage may vary with use requirements.

The Portable Skid Resistant Waste Containment System is comprised of a waste containment floor and alternatively, any number of containment wall housings which is determined by the shape. The containment wall housings are created by a series of folds and welds made around the perimeter, thus considered by inventor the fold and weld method, folded towards the center of the waste containment floor and welds applied along the rough edge of the containment wall housings parallel to the folded edge. Alternatively, the width of fold made is dependent of wall height desired, and is not mandated. A notch is then cut (joint allowance) from each of the containment wall housings at each of the angle changes to allow access to each containment wall housings, alternatively, this may be achieved prior or after to this point of progress of this manufacturing process. The containment wall housing erection is achieved by the user of the containment system, choosing and obtaining on his own accord, and is not a part of this patent application, the desired contents to be inserted in the containment wall housings to achieve the containment wall integrity and size requirements, alternatively, these containment wall housing inserts may follow this invention, as a separate patent application, with reference to this patent, by said inventor. The purpose of a alternatively user chosen containment wall housings insert is to allow versatility of said invention. Alternatively, if a user required a four sided containment system, that requires rigid walls, four PVC pipes may be used, of suitable lengths and diameters for each containment wall housings. A containment wall housing made of a six inch wall height, could conceivably accommodate any article inserted up to that six inch width size, the articles that are inserted into containment wall housings, may or may not be secured together, at the joint allowance, with a ninety degree elbow at each corner to connect the walls articles together. This connection is optional, and alternatively no connection of inserts may exist. Alternatively, the PVC pipe can be used for all walls or may be used with one or more other articles inserted, such as one made of foam, or any other suitable insert. The containment wall housing system of said invention, allows for the constant ability to interchange the contents within, since both ends of each containment wall housings are left open, to achieve the desired interior integrity of the erected containment wall housings, to be determined by users specifications, or inventor.

Alternatively, the size of the Portable Skid Resistant Waste Containment System may vary with designated use requirements. Alternatively, the shape of the Portable Skid Resistant Wash Containment System is of any geometric shape that comprises of 3 or more straight lines, of which each connect together continuously, forming an enclosed geometric shape, to which the material is cut to during the manufacturing process. A series of folds and welds (fold and weld method) are made around the perimeter and is the process of forming the containment wall housings, no matter the shape. This design and manufacturing process allows portability, versatility in size, shape and function ability, along with an added safety feature, for the user of the Skid Resistant Waste Containment System.

### DISCRIPTON OF DRAWINGS

The drawings represent the steps of the manufacturing process, and a visual aid to grasp the scope of the Skid Resistant Waste Containment System. They do not represent a particular size or the shape of the Skid Resistant Waste Containment System, since the established theory that the process of manufacturing allows for flexibility, and versatility to construct the Skid Resistant Waste Containment System of any shape or size. The drawing descriptions below lists the figure numbers (one figure per sheet) and part identifications within each figure.

FIG. 1. Represents step 1 and 2 of manufacturing process, a plan sample, sheet 1 of 6.

FIG. 1A The perimeter of the containment wall housing.

FIG. 1B The fold line.

FIG. 1C Waste containment floor perimeter.

FIG. 2. Represents the view with the containment wall housing folded in place, sheet 2 of 6.

FIG. 2A The perimeter of the containment wall housing, once folded in place.

FIG. 2E Containment wall housing.

FIG. 2D Folded edge of the containment wall housing.

FIG. 2I Joint allowance.

FIG. 3. Represents step 5 of manufacturing process, sheet 3 of 6.

FIG. 3F Weld connecting the front to the back of the containment wall housing.

FIG. 3E Containment wall housing.

FIG. 3C Waste containment floor perimeter.

FIG. 4. Represents step 6 of manufacturing process, sheet 4 of 6.

FIG. 4G Joint reinforcements.

FIG. 4H Weld attaching joint reinforcements to containment wall housing and to the waste containment floor.

FIG. 5. An example of one possible pattern to use in the application of the skid resistant product(s) applied, sheet 5 of 6.

FIG. 5G Joint Reinforcements

FIG. 5H Weld mark for joint reinforcement.

FIG. 5J Skid resistant product.

FIG. 6 Joint Reinforcement patterns, step 3 sheet 6 of 6

FIG. 6G Joint Reinforcement.

### MANUFACTURING PROCESS

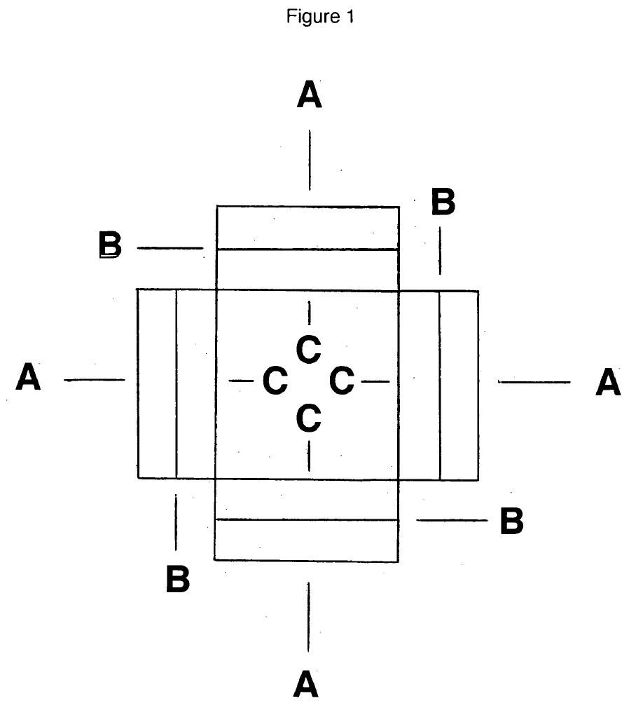

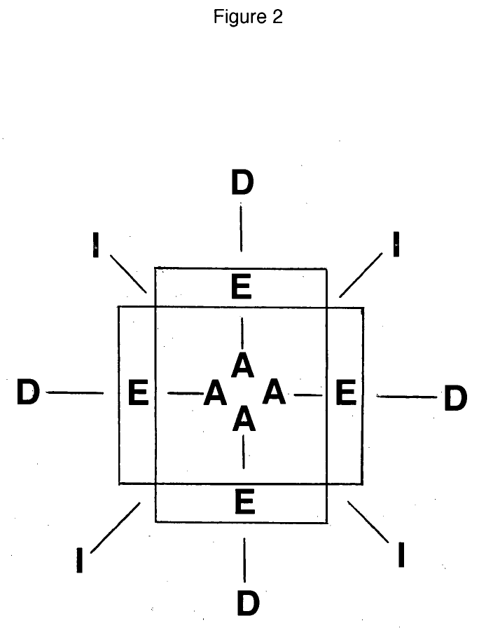

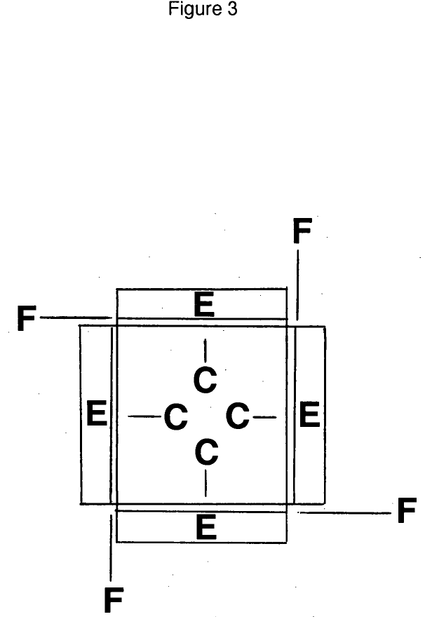

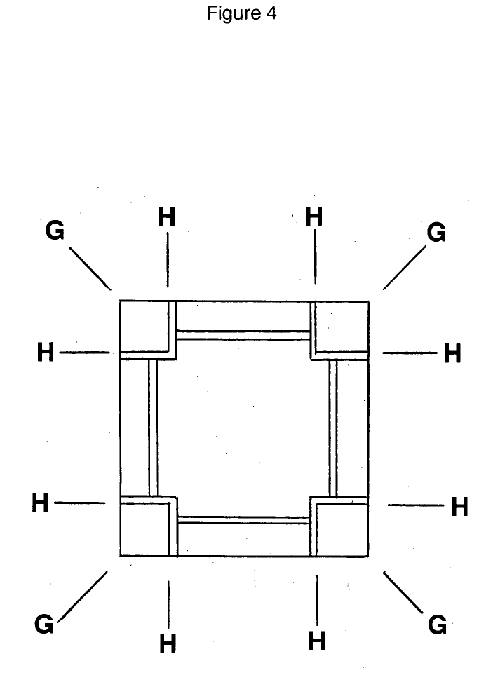

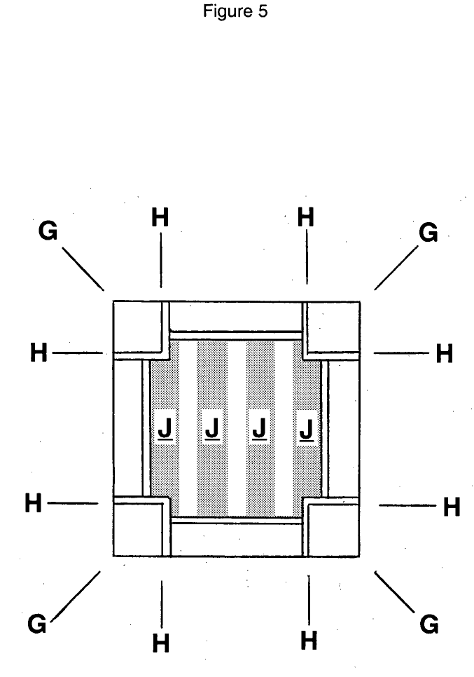

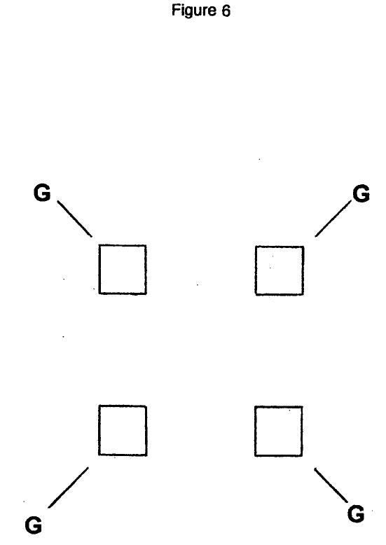

Step 1. Determine size, shape, material, containment wall housing height and floor area required for application requirements.
Step 2. Make plan, keeping all components of the plan to scale. Draw the shape per example shown in (FIG. 1). The plan should include the waste containment floor and the waste containment wall housings. Containment wall housings drawn on the outside perimeter of each straight edge of the waste containment floor, reflective of chosen size and each to scale. Containment wall housings height is double the desired finished size of the containment wall housings once folded in place. The joint reinforcement size should be large enough to comply with the description of application in step 6 herein and shown in FIG. 6G, sheet 6 of 6 of drawings.
Step 3. Mark and cut material per plan specifications.
Step 4. Mark fold lines (FIG. 1B), on containment wall housing (FIG. 1A).
Step 5. Fold containment wall housings on the marked fold lines, thus defining the waste containment floor perimeters and the finished size of the containment wall housings. Apply weld, along rough edge, parallel to fold to connect the front to the back on the containment wall housings (FIG. 3F). Thus creating the completed containment wall housings (FIG. 3E).
Step 6. Weld the joint reinforcements in place (FIG. 4G), sealing the front of joint allowance area, and overlapping the front sides of the vertical edges of each adjoining containment wall housings, and the waste containment floor, leaving access to the back of the joint allowance and access to the containment wall housing ends (FIG. 4H), thus sealing of interior waste containment area.
Step 7. Apply a skid resistant product(s) to surface of the waste containment component, as the application requires, for the particular product(s) used, that comply with desired results of manufacturing (FIG. 6J).

Alternatively, in the manufacturing process, the steps of manufacture should relate to the facility in which the manufacturing is taking place, and the conditions and resources which mandate the facility, along with the specialized needs of the waste containment system being manufactured. All of which may vary to accommodate individual or particular manufacturing situations, due to the versatility the fold and weld manufacturing method offers.

Alternatively, the joint allowance and the joint reinforcement elements may be omitted in the manufacturing process and the containment wall housing weld seam shortened at each end of the housings to generate same accessibility affect.

Summary of Manufacturing Process:

Determine shape of the Skid Resistant Waste Containment System by using any geometrical shape that is comprised of at least 3 straight lines or more, that makes an enclosed shape, of which connects continuously, each straight line representing the number of containment wall housings the system is comprised of. The shape chosen determines the containment systems shape. Determine the floor dimensions needed, the wall height needed for each side, and then double the wall height figure, then multiply that times the number of straight lines in your shape (quantity of containment wall housings). Begin folding each of the straight edges, towards the center of the shape, to half of the size of the wall height (forming containment wall housings and defining the waste containment floor). Cut a notch (joint allowance), between each containment wall housings, which would be at each angle change of each containment wall housings, to the width needed to create the access to each containment wall housings. Alternatively, the joint allowance step could be performed at a different time during the manufacturing process. Weld the folded containment wall housing in place along the rough edge, parallel to the folded edge, once the folded containment wall housings are welded, the containment wall housings are completed. Attach and seal the front (the front is the interior perimeter of containment area) of the joint allowance by welding the Joint reinforcements, preferably of the same material said containment system is comprised of, large enough to seal the front of the interior containment area, adjoining the two containment wall housings, and the waste containment floor, leaving the back open for continued access to the containment wall housings (the folded portion) thus sealing the containment area. Apply a skid resistant product(s) to the surface of the said waste containment system, as alternate application methods are required for the particular product used, for added a safety feature for users.

Alternatively, in the manufacturing process, the steps of manufacture should relate to the facility in which the manufacturing is taking place, and the conditions and resources which mandate the facility, along with the specialized needs of the waste containment system being manufactured. All of which may vary to accommodate individual or particular manufacturing situations, due to the versatility the fold and weld manufacturing method offers. Alternatively, the joint allowance and the joint reinforcement elements may be omitted in the manufacturing process and containment wall housings weld seam shortened at each end of the housings to generate same accessibility affect to the containment wall housings.

I claim my invention is:

1. Portable Skid Resistant Waste Containment System.

2. As per claim 1, said portable skid resistant waste containment system is comprised a waste containment floor and containment wall housings are comprised of preferably XR5.

3. As per claim 1, said system is portable.

4. As per claim 1, said system has an applied skid resistant product(s) to the surface in one or more application methods.

5. Portable Skid Resistant Waste Containment System manufacturing process.

6. As per claim 5, said manufacturing process is as follows
Step 1. Determine shape, size, material, containment wall size, joint reinforcements, joint allowances and floor area required for application requirements.
Step 2. Make plan, keeping all components of the plan to scale. In drawing a plan, plan should include the waste containment floor and the waste containment wall housings. Containment wall housings drawn on the outside perimeter of each straight edge of the waste containment floor, reflective of chosen size and shape and each to scale. Containment wall housings height is double the desired finished size of the containment wall housings once folded in place, and the joint allowances are cut between each of the containment wall housings, allowing constant access to the ends of each containment wall housings. The joint reinforcement size should be large enough to comply with the description of application in step 6 herein and definitions are as follows, Shape=Rectangular, square, triangular, etc., Size=The finished dimensions of containment system, Material=What the material comprises of, Containment Wall Height=The height of the containment walls, double this measurement to determine vertical measurement of containment wall housing, Joint Allowance=A section cut out of folded part of the material (the containment wall housing), that provides the access to form a junction of each containment wall housing, Joint Reinforcement=Is a pre-measured piece of material, that is large enough to cover the front of the joint allowance section, connecting it to both adjoining containment wall housings and the containment wash floor. Floor Area=The perimeter of the size of the floor. (floor dimensions)
Step 3. Mark and cut material per plan specifications.
Step 4. Mark fold lines, on containment wall housings.
Step 5. Fold containment wall housings on the marked fold lines, thus defining the waste containment floor perimeters and the finished size of the containment wall housings. Apply weld, along rough edge, parallel to fold to connect the front to the back on the containment wall housing, thus creating the completed containment wall housings.
Step 6. Weld the joint reinforcements in place, sealing the front of joint allowance area, and overlapping the front sides of the vertical edges of each adjoining containment wall housings, and the waste containment floor, leaving access to the back of the joint allowance and access to the containment wall housing ends with desired results of manufacturing. Alternatively, in the manufacturing process, the steps of manufacture should relate to the facility in which the manufacturing is taking place, and the conditions and resources which mandate the facility, along with the specialized needs of the waste containment system being manufactured. All of which may vary to accommodate individual or particular manufacturing situations, due to the versatility the fold and weld manufacturing method offers. Alternatively, the joint allowance and the joint reinforcement elements may be omitted in the manufacturing process and containment wall housing weld seam shorted at each end of the housings to generate same accessibility affect.
